(19) United States
(12) Patent Application Publication
(10) Pub. No.: US 2014/0053717 A1
(43) Pub. Date: Feb. 27, 2014

(54) Bullet Resistant Dry Erase Boards

(71) Applicant: Barton Richard Bowen, Snowflake, AZ (US)

(72) Inventor: Barton Richard Bowen, Snowflake, AZ (US)

(21) Appl. No.: 13/770,465

(22) Filed: Feb. 19, 2013

Related U.S. Application Data
(60) Provisional application No. 61/749,189, filed on Jan. 4, 2013.

(51) Int. Cl. F41H 5/04; B43L 1/00

(52) U.S. Cl. CPC F41H 5/0478; B43L 1/00
USPC 89/36.02

(57) ABSTRACT

The art for this invention is combining the previous arts of (1) dry erase boards and (2) bullet resistant materials into one art resulting in a bullet-resistant dry erase board that has a dual purpose of both academic learning and physical safety from a gunman's bullets.

### BACKGROUND

Dry erase whiteboards are commonly used in all classrooms in education environments, especially public and private schools (but also in other industries including business, medical, government, etceteras. Currently, dry erase whiteboards are made out of a variety of materials of many shapes and sizes.

My idea is that dry erase whiteboards could be used for a dual purpose: academic learning as well as physical safety or protection from bodily harm by using the dry erase board as a shield from a gunman's bullets. In addition to the widely embraced benefit of using a dry erase board for academic learning and student engagement, a dry erase board created out of a light weight ballistic material such as a polycarbonate, fiberglass, polyethylene-resin, or similar composite could help save lives in the classroom.

Bullet-Proof Dry Erase Boards can be placed under, in, or hooked onto student's desks or backpacks for quick access and protection. School administrators can conduct school wide drills and various training exercises to teach students how to effectively protect their vital body parts from a gunman who enters the school. Staff, administrators, secretaries, etceteras could also have the boards near their desks to provide quick access and protection in the case of armed intruders.

### DESCRIPTION SUMMARY/DETAILED DESCRIPTION

This utility patent is specifically for the manufacture of any dry erase whiteboard product that will be used for the dual purpose of academic learning and physical safety from a gunman's bullets to include any dry erase board manufactured from a bullet-proof or bullet-resistant material including polycarbonate, fiberglass, polyethylene resin composites or any similar light weight, bullet-resistant material, of any thickness, width, or length and of any customized exterior design (including handles of any kind).

1. This utility patent is specifically for the manufacture of any dry erase whiteboard product that will be used for the dual purpose of academic learning and physical safety from a gunman's bullets to include any dry erase board manufactured from a bullet-proof or bullet-resistant material including polycarbonate, fiberglass, polyethylene resin composites or any similar light weight, bullet-resistant material, of any thickness, width, or length, and of any customized exterior design (including handles of any kind).
